(19) United States
(12) Patent Application Publication
(10) Pub. No.: US 2014/0380500 A1
(43) Pub. Date: Dec. 25, 2014

(54) APPARATUS AND METHOD FOR CONTROLLING ACCESS TO WEBSITES USING HISTORY OF ACCESS OF ADMINISTRATOR

(71) Applicant: ELECTRONICS AND TELECOMMUNICATIONS RESEARCH INSTITUTE, Daejeon-city (KR)

(72) Inventors: Ju-Young PARK, Daejeon (KR); Ok-Jo JUNG, Daejeon (KR); Shin-Gak KANG, Daejeon (KR)

(73) Assignee: ELECTRONICS AND TELECOMMUNICATIONS RESEARCH INSTITUTE, Daejeon-city (KR)

(21) Appl. No.: 14/310,395

(22) Filed: Jun. 20, 2014

(30) Foreign Application Priority Data
Jun. 24, 2013 (KR) 10-2013-0072733
Feb. 11, 2014 (KR) 10-2014-0015488

(51) Int. Cl. H04L 29/06

(52) U.S. Cl. CPC H04L 63/10
USPC 726/27

(57) ABSTRACT

An apparatus and method for controlling access to websites using a history of access of an administrator are disclosed. The apparatus includes a privilege checking unit, an access control release unit, and an access control unit. The privilege checking unit determines whether the access privileges of a user are administrator privileges when the user attempts to access a website. The access control release unit sets the website to an access-allowed state if the access privileges of the user are administrator privileges. The access control unit controls access to the website if the access privileges of the user are not administrator privileges, nor is the website in an access-allowed state.

### CROSS REFERENCE TO RELATED APPLICATIONS

This application claims the benefit of Korean Patent Application Nos. 10-2013-0072733 and 10-2014-0015488, filed on Jun. 24, 2013 and Feb. 11, 2014, respectively, which are hereby incorporated by reference herein in their entirety.

### BACKGROUND OF THE INVENTION

1. Technical Field

The present disclosure relates to an apparatus and method for controlling access to websites using a history of access of an administrator and, in particular, to an apparatus and method for controlling access to websites using a history of access of an administrator, which are capable of preventing a user having no administrator privileges from accessing a website that has not been accessed by an administrator and allowing the user to access only a website that has been accessed by the administrator.

2. Description of the Related Art

Recently, a drive for the establishment of a smart school, that is, a paper/bookless classroom environment, has increasingly expanded.

Although there have been technologies for designating a list of harmful websites and blocking access to harmful websites, a problem arises in a smart school environment using smart devices in that students access websites irrelevant to a corresponding class, other than harmful websites, thereby harming the concentration of students in a class.

Korean Patent Application Publication No. 10-2010-0018286 discloses a harmful website access blocking technology. This technology is configured to prevent unauthenticated users from accessing harmful websites using subscription identification information, which is a type of user information, and harmful website information.

While Korean Patent Application Publication No. 10-2010-0018286 merely presents technology for blocking access to harmful websites in a smart school environment, it does not mention or suggest technology for preventing students from indiscriminately accessing websites irrelevant to a corresponding class, other than harmful sites.

Accordingly, in a smart school environment, there is an urgent need for new website access control technology for setting only websites accessed by an administrator to an access-allowed state, thereby enabling the administrator to easily change the privileges of access to websites.

### SUMMARY OF THE INVENTION

The present invention may be intended to prevent a user having no administrator privileges from accessing a website that has not been accessed by an administrator and allow the user to access only a website that has been accessed by the administrator, thereby providing a more convenient website access control service.

The present invention may be intended to enable a user having no administrator privileges to access a specific website by means of an administrator action of accessing the corresponding website once, thereby providing a more rapid website access control service.

The present invention may be intended to automatically prevent a user having no administrator privileges from accessing a specific website when an administrator accesses the corresponding website once and then a specific period has elapsed, so that access privileges are returned to an original state without requiring a separate command, thereby providing a more convenient website access control service.

In accordance with an aspect of the present invention, there is provided an apparatus for controlling access to websites using a history of access of an administrator, the apparatus including a privilege checking unit configured to determine whether the access privileges of a user are administrator privileges when the user attempts to access a website; an access control release unit configured to set the website to an access-allowed state if the access privileges of the user are administrator privileges; and an access control unit configured to control access to the website if the access privileges of the user are not administrator privileges, nor is the website in an access-allowed state.

The access control release unit may set the website to an access-controlled state if the website has remained in an access-allowed state for longer than a preset access-allowed time.

The access control release unit may count again the access-allowed time from the time at which the user attempts to access the website if the access privileges of the user are administrator privileges and also the website is in an access-allowed state.

The access control release unit may set the website to an access-allowed state in a variable manner depending on whether the website is a preset permanently allowed web site.

The access control release unit may set the website to an access-allowed state if the access privileges of the user are administrator privileges, nor is the website a permanently allowed website.

The access control unit may allow access to the website if the access privileges of the user are administrator privileges.

The access control release unit may activate a timer adapted to start to increase from the time at which the website has been set to the access-allowed state, and may set the website to an access-controlled state if the time of the timer time has exceeded a preset access-allowed time.

The access control release unit may reset the timer if the access privileges of the user are administrator privileges and also the website is in an access-allowed state.

In accordance with another aspect of the present invention, there is provided a method of controlling access to websites using a history of access of an administrator, the method including determining whether the access privileges of a user are administrator privileges when the user attempts to access a website; setting the website to an access-allowed state if the access privileges of the user are administrator privileges; and controlling access to the website if the access privileges of the user are not administrator privileges, nor is the website in an access-allowed state.

The method may further include setting the website to an access-controlled state if the website has remained in an access-allowed state for longer than a preset access-allowed time.

Setting the website to the access-allowed state may include counting again the access-allowed time from the time at which the user attempts to access the website if the access privileges of the user are administrator privileges and also the website is in an access-allowed state.

Setting the website to the access-allowed state may include setting the website to an access-allowed state in a variable manner depending on whether the website is a preset permanently allowed website.

Setting the website to the access-allowed state may include setting the website to an access-allowed state if the access privileges of the user are administrator privileges, nor is the website a permanently allowed website.

The method may further include allowing access to the website if the access privileges of the user are administrator privileges.

Setting the website to the access-controlled state may include activating a timer adapted to start to increase from the time at which the website has been set to the access-allowed state, and setting the website to an access-controlled state if the time of the timer time has exceeded a preset access-allowed time.

Setting the website to the access-allowed state may include resetting the timer if the access privileges of the user are administrator privileges and also the website is in an access-allowed state.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram of a system for controlling access to websites using a history of access of an administrator according to an embodiment of the present invention;

FIG. 2 is a block diagram illustrating an example of the apparatus for controlling access to web sites, which is illustrated in FIG. 1;

FIG. 3 is an operation flowchart of an example of a method of controlling access to websites using a history of access of an administrator according to an embodiment of the present invention; and

FIG. 4 is an operation flowchart of another example of a method of controlling access to websites using a history of access of an administrator according to an embodiment of the present invention.

### DESCRIPTION OF THE PREFERRED EMBODIMENTS

The present invention is described in detail below with reference to the accompanying drawings. In the following description of the present invention, detailed descriptions of known functions and configurations which are deemed to make the gist of the present invention obscure will be omitted. Furthermore, it should be noted that same reference numerals are used to designate the same or similar elements throughout the drawings.

It should be noted that the terms and words used in the specification and the claims should not be construed as being limited to ordinary meanings or dictionary definitions but should be construed as meanings or concepts corresponding with the technical spirit of the present invention, based on the principle that the inventor can appropriately define the concepts of the terms to best describe his own invention. Meanwhile, the embodiments described in the specification and the configurations illustrated in the drawings are merely examples and do not exhaustively present the technical spirit of the present invention. Accordingly, it should be appreciated that there may be various equivalents and modifications that can replace the embodiments and the configurations at the time at which the present application is filed. Furthermore, the terms “first” and “second” are used to describe various components, and are used merely for the purpose of distinguishing various components, not for the purpose of limiting the components.

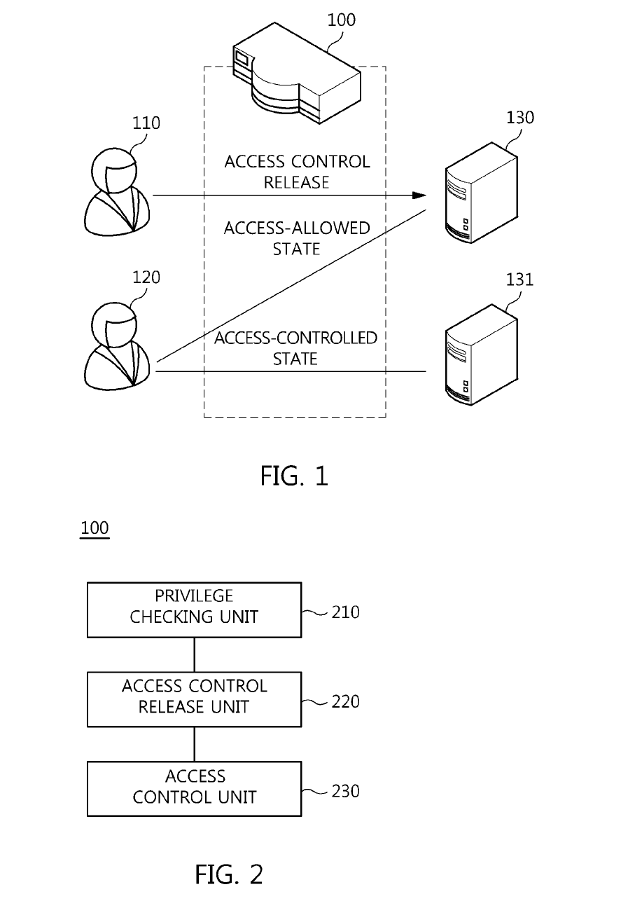

FIG. 1 is a diagram of a system for controlling access to websites using a history of access of an administrator according to an embodiment of the present invention.

Referring to FIG. 1, the system for controlling access to websites using a history of access of an administrator includes an apparatus 100 for controlling access to websites, users 110 and 120, and websites 130 and 131 accessible via the apparatus 100 for controlling access to websites.

The apparatus 100 for controlling access to websites determines whether or not the access privileges of each of users 110 and 120 are administrator privileges when the user 110 or 120 accesses one of the websites 130 and 131.

In this case, the apparatus 100 for controlling access to websites may determine whether or not the access privileges of each of the users 110 and 120 are administrator privileges or non-administrator privileges using an accessible host table.

For example, if the user 110 is included in the accessible host table, the apparatus 100 for controlling access to websites may determine that the access privileges of the user 110 are administrator privileges. In a similar manner, if the user 120 is not included in the accessible host table, the apparatus 100 for controlling access to websites may determine that the access privileges of the user 120 are non-administrator privileges.

The apparatus 100 for controlling access to websites sets the website 130 to an access-allowed state if the access privileges of the user 110 are administrator privileges.

In this case, the apparatus 100 for controlling access to websites may control access to the websites 130 and 131 using an access-allowed site table including a list of websites set to an access-allowed state.

That is, only the list of websites set to an access-allowed state is stored in the access-allowed site table, and websites absent in the access-allowed site table are automatically set to an access-controlled state.

The users 110 and 120 access websites via the apparatus for controlling access to websites 110.

In this case, the access privileges of each of the users 110 and 120 may be any one of administrator privileges and non-administrator privileges.

For example, the access privileges of the user 110 may be administrator privileges, while the access privileges of the user 120 may be non-administrator privileges.

In this case, the access privileges of each of the users 110 and 120 may be stored in the accessible host table of the apparatus for controlling access to websites 110.

The administrator 110 may access the website 130 via the apparatus for controlling access to websites 110, and may then switch the website 130 to an access-allowed state in which the website 130 is accessible to the non-administrator 120.

The non-administrator 120 may access the website 130 switched to an access-allowed state, and may not access the website 131 that has not been accessed by the administrator 110.

FIG. 2 is a block diagram illustrating an example of the apparatus 100 for controlling access to websites, which is illustrated in FIG. 1.

Referring to FIG. 2, the apparatus 100 for controlling access to websites, which is illustrated in FIG. 1, includes a privilege checking unit 210, an access control release unit 220, and an access control unit 230.

The privilege checking unit 210 determines whether or not the access privileges of a user are administrator privileges when the user accesses a website.

In this case, the privilege checking unit 210 may determine whether the access privileges of the user are administrator privileges or non-administrator privileges using an accessible host table.

In this case, the accessible host table may include an administrator-privilege user list.

The access control release unit 220 sets the website to an access-allowed state if the access privileges of the user are administrator privileges.

In this case, the access control release unit 220 may add a list of websites set to an access-allowed state to an access-allowed site table, and the access control unit 230 may control access to the website using the access-allowed site table.

That is, only the list of websites set to an access-allowed state is stored in the access-allowed site table, and websites absent in the access-allowed site table are automatically maintained in an access-controlled state.

In this case, the access control release unit 220 may set the website to an access-controlled state if the website has remained in the access-allowed state for longer than a preset access-allowed time.

For example, the access control release unit 220 may activate a timer adapted to start to increase from the time at which the website has been set to the access-allowed state, and may set the website to an access-controlled state if the time of the timer has exceeded the preset access-allowed time.

In this case, although the timer may increase from zero, it may operate to count down from the access-allowed time to zero.

In this case, the access control release unit 220 may activate a timer adapted to start to increase from the time at which the website has been set to the access-allowed state, and may delete the website from the access-allowed site table if the time of the timer has exceeded the preset access-allowed time, thereby setting the website to an access-controlled state.

In this case, the access control release unit 220 may count again the access-allowed time from the time at which the user attempts to access the website if the access privileges of the user are administrator privileges and the website is in an access-allowed state.

In this case, the timer may be reset to zero if the timer counts up from zero, while the timer may be reset to the access-allowed time if the timer counts down from the access-allowed time to zero.

In this case, access control release unit 220 may set the website to an access-allowed state in a variable manner depending on whether the website is a preset permanently allowed website.

In this case, the access control release unit 220 may set the website to an access-allowed state if the access privileges of the user are administrator privileges and also the website is not a permanently allowed website.

In this case, the permanently allowed website may be a website in a permanently access-allowed state because the website is present in the access-allowed site table but a timer has not been applied to the website.

In this case, the permanently allowed website is newly set to or released from a permanently allowed state by a user having administrator privileges.

In this case, the access control release unit 220 may reset the timer if the access privileges of the user are administrator privileges and also the website is in an access-allowed state.

The access control unit 230 controls access to the website if the access privileges of the user are not administrator privileges and also the website is not in an access-allowed state.

In this case, the access control unit 230 may allow access to the website if the access privileges of the user are administrator privileges.

In this case, the access control unit 230 may allow access to a website if the website that a user attempts to access has been added to the access-allowed site table, and may not allow access to the website if the website has not been added to the access-allowed site table.

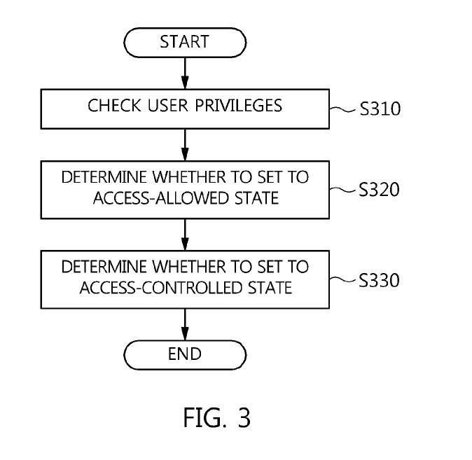

FIG. 3 is an operation flowchart of an example of a method of controlling access to websites using a history of access of an administrator according to an embodiment of the present invention.

Referring to FIG. 3, the method of controlling access to websites using a history of access of an administrator according to this embodiment of the present invention includes step S310 of determining whether or not the access privileges of a user are administrator privileges when the user attempts to access a website.

In this case, at step S310, it is determined using an accessible host table whether the access privileges of the user are administrator privileges or non-administrator privileges.

In this case, the accessible host table may include an administrator-privilege user list.

Furthermore, the method of controlling access to websites using a history of access of an administrator according to this embodiment of the present invention further includes step S320 of setting the website to an access-allowed state if the access privileges of the user are administrator privileges.

In this case, at step S320, a list of websites set to an access-allowed state may be added to the access-allowed site table.

In this case, at step S320, the website may be set to an access-controlled state if the website has remained in the access-allowed state for longer than a preset access-allowed time.

For example, at step S320, a timer adapted to start to increase from the time at which the website has been set to the access-allowed state may be activated, and the website may be set to an access-controlled state if the time of the timer has exceeded the preset access-allowed time.

In this case, although the timer may increase from zero, it may operate to count down from the access-allowed time to zero.

In this case, at step S320, a timer adapted to start to increase from the time at which the website has been set to the access-allowed state may be activated, and the website may be deleted from the access-allowed site table if the time of the timer has exceeded the preset access-allowed time, thereby setting the website to an access-controlled state.

In this case, at step S320, the access-allowed time may be counted again from the time at which the user attempts to access the website if the access privileges of the user are administrator privileges and the website is in an access-allowed state.

In this case, the timer may be reset to zero if the timer counts up from zero, while the timer may be reset to the access-allowed time if the timer counts down from the access-allowed time to zero.

In this case, at step S320, the website may be set to an access-allowed state in a variable manner depending on whether the website is a preset permanently allowed web site.

In this case, the access control release unit 220 may set the website to an access-allowed state if the access privileges of the user are administrator privileges and also the website is not a permanently allowed website.

In this case, the permanently allowed website may be a website in a permanently access-allowed state because the website is present in the access-allowed site table but a timer has not been applied to the website.

In this case, the permanently allowed website is newly set to or released from a permanently allowed state by a user having administrator privileges.

In this case, at step S320, the timer may be reset if the access privileges of the user are administrator privileges and also the website is in an access-allowed state.

Furthermore, the method of controlling access to websites using a history of access of an administrator according to this embodiment of the present invention further includes step S330 of controlling access to the website if the access privileges of the user are not administrator privileges and also the website is not in an access-allowed state.

In this case, at step S330, access to the website may be allowed if the access privileges of the user are administrator privileges.

In this case, at step S330, access to a website may be allowed if the website that a user attempts to access has been added to the access-allowed site table, and may not be allowed if the website has not been added to the access-allowed site table.

In this case, at step S330, access to the website may be controlled using an access-allowed site table.

That is, only the list of websites set to an access-allowed state is stored in the access-allowed site table, and websites absent in the access-allowed site table are automatically set to an access-controlled state.

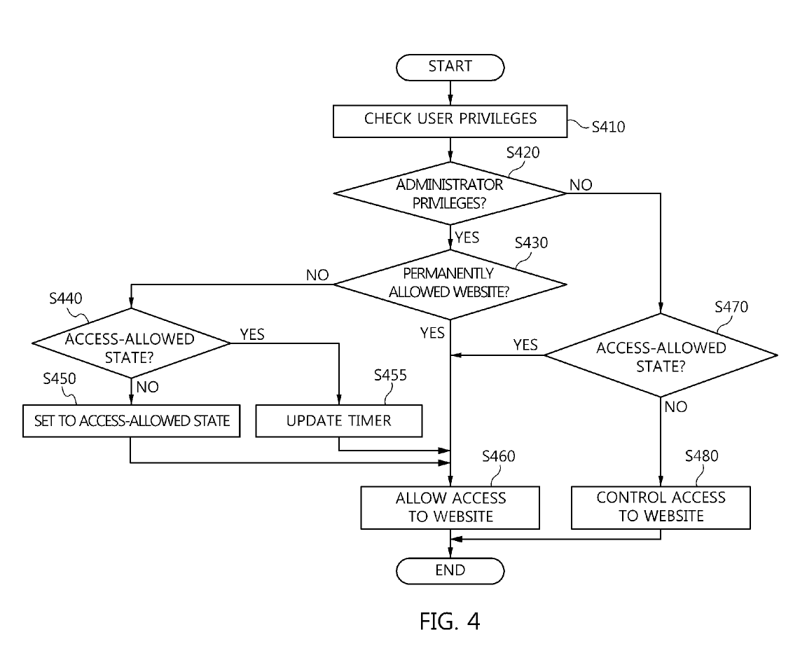

FIG. 4 is an operation flowchart of another example of a method of controlling access to websites using a history of access of an administrator according to an embodiment of the present invention.

Referring to FIG. 4, the method of controlling access to websites using a history of access of an administrator according to this embodiment of the present invention includes step S410 of determining whether the access privileges of the user are administrator privileges when a user attempts to access a website.

Furthermore, the method of controlling access to websites using a history of access of an administrator according to this embodiment of the present invention includes step S420 of determining whether the access privileges of the user are administrator privileges or non-administrator privileges using an accessible host table.

In this case, the accessible host table may include an administrator-privilege user list.

The method of controlling access to websites using a history of access of an administrator according to an embodiment of the present invention further includes step S430 of determining whether or not the website is a permanently allowed website.

In this case, the permanently allowed website may be a website in a permanently access-allowed state because the website is present in the access-allowed site table but a timer has not been applied to the website.

In this case, at step S430, whether or not the website is a permanently allowed website is determined by checking an access-allowed site table including a list of websites set to an access-allowed state and checking whether a timer has been applied.

In this case, the permanently allowed website is newly set to or released from a permanently allowed state by a user having administrator privileges.

If, as a result of the checking at step S430, it is determined that the web site is a permanently allowed website, the method of controlling access to websites using a history of access of an administrator according to this embodiment of the present invention includes step S460 of allowing the access of the user to the website.

If, as a result of the checking at step S430, it is determined that the website is not a permanently allowed website, the method of controlling access to websites using a history of access of an administrator according to this embodiment of the present invention includes step S440 of determining whether the website is in an access-allowed state.

If, as a result of the checking at step S440, it is determined that the website is in an access-allowed state, the method of controlling access to websites using a history of access of an administrator according to this embodiment of the present invention includes step S455 of updating the timer with an initial value.

If, as a result of the checking at step S440, it is determined that the website is not in an access-allowed state, the method of controlling access to websites using a history of access of an administrator according to this embodiment of the present invention includes step S450 of setting the website to an access-allowed state at step S450.

The method of controlling access to websites using a history of access of an administrator according to this embodiment of the present invention further includes step S460 of allowing the access of the user to the website if the website is set to an access-allowed state at step S450 or the timer is updated with the initial value at step S455.

If, as a result of the checking at step S420, it is determined that the access privileges of the user are non-administrator privileges, the method of controlling access to websites using a history of access of an administrator according to this embodiment of the present invention includes step S470 of determining whether the website is in an access-allowed state.

If, as a result of the checking at step S470, it is determined that the website is in an access-allowed state, the method of controlling access to websites using a history of access of an administrator according to this embodiment of the present invention includes step S460 of allowing the access of the user to the website.

If, as a result of the checking at step S470, it is determined that the website is not in an access-allowed state, the method of controlling access to websites using a history of access of an administrator according to this embodiment of the present invention includes step S480 of controlling the access of the user to the web site.

The method of controlling access to websites using a history of access of an administrator according to at least one embodiment of the present invention may be implemented as a program or a smartphone app that can be executed by various computer means. In this case, the program or smartphone app may be recorded on a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and the vice versa.

As described above, the apparatus and method for controlling access to websites using a history of access of an administrator according to the present invention are not limited and applied to the configurations and operations of the above-described embodiments, but all or some of the embodiments may be selectively combined and configured so that the embodiments may be modified in various ways.

The present invention may have the advantage of preventing a user having no administrator privileges from accessing a website that has not been accessed by an administrator and allow the user to access only a website that has been accessed by the administrator, thereby providing a more convenient website access control service.

The present invention may have the advantage of enabling a user having no administrator privileges to access a specific web site by means of an administrator action of accessing the corresponding website once, thereby providing a more rapid website access control service.

The present invention may have the advantage of automatically preventing a user having no administrator privileges from accessing a specific website when an administrator accesses the corresponding website once and then a specific period has elapsed, so that access privileges are returned to an original state without requiring a separate command, thereby providing a more convenient website access control service.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for controlling access to websites using a history of access of an administrator, the apparatus comprising:
a privilege checking unit configured to determine whether access privileges of a user are administrator privileges when the user attempts to access a website;
an access control release unit configured to set the website to an access-allowed state if the access privileges of the user are administrator privileges; and
an access control unit configured to control access to the website if the access privileges of the user are not administrator privileges, nor is the website in an access-allowed state.

2. The apparatus of claim 1, wherein the access control release unit sets the website to an access-controlled state if the website has remained in an access-allowed state for longer than a preset access-allowed time.

3. The apparatus of claim 2, wherein the access control release unit counts again the access-allowed time from a time at which the user attempts to access the website if the access privileges of the user are administrator privileges and also the website is in an access-allowed state.

4. The apparatus of claim 3, wherein the access control release unit sets the website to an access-allowed state in a variable manner depending on whether the website is a preset permanently allowed website.

5. The apparatus of claim 4, wherein the access control release unit sets the website to an access-allowed state if the access privileges of the user are administrator privileges, nor is the website a permanently allowed website.

6. The apparatus of claim 5, wherein the access control unit allows access to the website if the access privileges of the user are administrator privileges.

7. The apparatus of claim 2, wherein the access control release unit activates a timer adapted to start to increase from a time at which the website has been set to the access-allowed state, and sets the website to an access-controlled state if a time of the timer time has exceeded a preset access-allowed time.

8. The apparatus of claim 7, wherein the access control release unit resets the timer if the access privileges of the user are administrator privileges and also the website is in an access-allowed state.

9. A method of controlling access to websites using a history of access of an administrator, the method comprising:
determining whether access privileges of a user are administrator privileges when the user attempts to access a website;
setting the website to an access-allowed state if the access privileges of the user are administrator privileges; and
controlling access to the website if the access privileges of the user are not administrator privileges, nor is the website in an access-allowed state.

10. The method of claim 9, further comprising setting the website to an access-controlled state if the website has remained in an access-allowed state for longer than a preset access-allowed time.

11. The method of claim 10, wherein setting the website to the access-allowed state comprises counting again the access-allowed time from a time at which the user attempts to access the website if the access privileges of the user are administrator privileges and also the website is in an access-allowed state.

12. The method of claim 11, wherein setting the website to the access-allowed state comprises setting the website to an access-allowed state in a variable manner depending on whether the website is a preset permanently allowed website.

13. The method of claim 12, wherein setting the website to the access-allowed state comprises setting the website to an access-allowed state if the access privileges of the user are administrator privileges, nor is the website a permanently allowed website.

14. The method of claim 13, further comprising allowing access to the website if the access privileges of the user are administrator privileges.

15. The method of claim 10, wherein setting the website to the access-controlled state comprises activating a timer adapted to start to increase from a time at which the website has been set to the access-allowed state, and setting the website to an access-controlled state if a time of the timer time has exceeded a preset access-allowed time.

16. The method of claim 15, wherein setting the website to the access-allowed state comprises resetting the timer if the access privileges of the user are administrator privileges and also the website is in an access-allowed state.
